(19) United States
(12) Patent Application Publication
(10) Pub. No.: US 2023/0018010 A1
(43) Pub. Date: Jan. 19, 2023

(54) RAILWAY SELF-GENERATING EXPRESS FREIGHT CAR BOGIE

(71) Applicant: CRRC MEISHAN CO., LTD., Meishan, Sichuan (CN)

(72) Inventors: Jun LIAO, Meishan, Sichuan (CN); Ji ZHU, Meishan, Sichuan (CN); Jun YANG, Meishan, Sichuan (CN); Chang WU, Meishan, Sichuan (CN); Xianfeng ZHANG, Meishan, Sichuan (CN); Dong LI, Meishan, Sichuan (CN); Hanjiang LUO, Meishan, Sichuan (CN); Rui ZHANG, Meishan, Sichuan (CN); Guangcai ZHANG, Meishan, Sichuan (CN); Chengli FENG, Meishan, Sichuan (CN); Yungui WANG, Meishan, Sichuan (CN); Jiale LI, Meishan, Sichuan (CN); Bing LIU, Meishan, Sichuan (CN); Lin XIE, Meishan, Sichuan (CN); Zhi XU, Meishan, Sichuan (CN)

(21) Appl. No.: 17/757,018

(22) PCT Filed: Jul. 23, 2020
(86) PCT No.: PCT/CN2020/103904

§ 371 Date: Jun. 8, 2022

(30) Foreign Application Priority Data
Dec. 20, 2019 (CN) 201911326263.0

(51) Int. Cl. B61F 15/20; B61F 5/30

(52) U.S. Cl. CPC B61F 15/20; B61F 5/305

(57) ABSTRACT

A railway self-generating express freight car bogie has a wheel-axle assembly, frame, journal box suspension device, bolster, foundation brake, side bearing, empty/load auto-adjustment equipment, central suspension device, longitudinal traction device, vertical damper and lateral damper. An axle-end generator is connected at the outer end of an axle of the wheel-axle assembly, the rotor part of the axle-end generator is connected to the end bearing of the wheel-axle assembly by the axle-end bolts, and the stator part is connected to the mount of the journal box suspension devices. The bogie is designed according to the zero-wear concept, and a large number of rubber components and hydraulic dampers are used to improve the lateral stability, linear stability and curve passing performance of the car, so that the bogie is highly adaptable to railway lines, and can meet the operating requirements within 160 km/h and reduce the workload of bogie operation and maintenance.

### TECHNICAL FIELD

The present invention relates to the design technique of railway freight transportation equipment, and more particularly, to the design technique of a freight car bogie, and belongs to the technical field of design and manufacture of railway vehicles and electromechanical products.

### BACKGROUND

At present, the speed of the main bogies of railway freight cars in China generally reaches 120 km/h. However, higher speed can be hardly achieved as it is limited by the structure. The traditional three-piece bogie has a large non-suspended weight, which increases the wheel-rail contact force, resulting in serious wear on the wheel, rail, and suspension device. The dynamic performance of the bogie deteriorates with the rise of speed, the vibration acceleration of the car increases, and the stability decreases. Meanwhile, the running state of freight cars also lacks intelligent monitoring due to the absence of electric energy input. With the increase of high value-added cargo transportation by railway, especially express container transportation, there is an urgent need for an express freight car bogie with high speed, excellent dynamic performance, and self-generating function.

### SUMMARY

The present invention discloses a railway self-generating express freight car bogie according to the defects of the prior art. The problem to be solved by the present invention is to provide an express freight car bogie that meets the development needs of express container transportation, can run at a speed of up to 160 km/h, and has excellent dynamic performance and self-generating function.

The present invention is realized by the following technical solution:

A railway self-generating express freight car bogie includes wheel-axle assembly, frame, journal box suspension device, bolster, foundation brake, side bearing, empty/load auto-adjustment equipment, central suspension device, longitudinal traction device, vertical damper and lateral damper, characterized in that: an axle-end generator is connected at the outer end of an axle of the wheel-axle assembly, the rotor part of the axle-end generator is connected to the end bearing of the wheel-axle assembly by the axle-end bolts, and the stator part is connected to the mount of the journal box suspension devices; the frame is located above the four journal box suspension devices, and the two ends of the bolster are respectively fixed on the inner suspension seat in the middle of the side beam of the frame through the central suspension device.

The central suspension device is an elastic element formed by a metal plate and vulcanized rubber.

The journal box suspension device has the journal box body which is connected with the axle of the wheel-axle assembly, and the top rubber spring of the journal box body. Meanwhile, to facilitate installation and maintenance of the vertical damper, a vertical damper mount is provided at one end of the journal box body, and a circular mounting hole at the other end for mounting the rubber node of the positioning arm. The circular mounting hole and the rubber node of the positioning arm are in an interference fit.

The top rubber spring of the journal box body is an elastic element formed by a metal plate and vulcanized rubber.

The rubber node of the positioning arm is an elastic element formed by a metal mandrel and vulcanized rubber. The rubber node of the positioning arm allows the journal box to have a great displacement in the up and down directions relative to the frame. The design of the rubber part realizes different positioning stiffness of the journal box during longitudinal and transverse displacement to meet the requirements of different elastic positioning stiffness in the longitudinal and transverse directions.

The frame is connected to the journal box suspension device through the top rubber spring of the journal box body; the vertical damper mount at one end of the journal box body is connected to the frame side beam through the vertical damper.

The frame is welded with two sets of box-type side beams and two parallel tubular cross beams passing through them. All components arranged on the frame are fixed by welding. A seat is provided on the inner side of the middle part of the side beams for mounting the central suspension device.

The components include unit braking system hanger, traction device mount, lateral damper mount, brake pipe hanger, suspension seat, lateral stop mount, spherical hinge mount, and vertical damper mount frame. The brake is a disc brake, having four systems matched with four wheels respectively, and each system includes a brake caliper device set arranged on the cross beam and a brake disc device on the axle. The side beam on one side of the frame is provided with empty/load auto-adjustment equipment. Longitudinal traction devices connected with the bolster are provided at both ends of the middle part of each cross beam of the frame, and a lateral damper connected with the bolster is provided on each side beam of the frame.

The bolster of the present invention is a box beam structure welded with stencil plates, including upper cover plate, web plate and lower cover plate; the length of the bolster is smaller than the center distance of the bogie journal and is placed on the inside of the bogie frame; the cross-section of the bolster is a U-shaped structure with two wings, with the middle part lower than the two ends.

A lower center plate is provided on the upper surface of the U-shaped structure of the bolster, and a lateral damper mount on the lower surface. Side bearing boxes are provided at the two ends of the U-shaped structure. Traction device mounts are provided at the two ends and the U-shaped transition section of the lower surface of the U-shaped structure of the bolster.

The primary vibration damping system of the bogie is composed of a journal box suspension device and a vertical damper.

The side beam is a box beam structure welded with stencil plates, including upper cover plate, web plate and lower cover plate; the cross-section of the side beam is a U-shaped structure with two wings, with the middle part lower than the two ends; a suspension seat integrated with the lower cover plate is provided on the inner side of the U-shaped structure.

Lateral stop mounts are provided in the middle of the upper plane of the U-shaped structure of the two side beams of the bogie frame.

The positioning of the bogie journal box suspension device is realized by the positioning arm-type journal box. The journal box has two mounting holes and a vertical damper mount to form a positioning arm. The larger hole in the middle is used to fit the axle bearing, and the smaller hole at one end is used to mount the rubber node of the positioning arm. The rubber node is connected to the mount welded to the frame. The vertical damper mount at the other end is connected to the frame through the vertical damper. In the dynamic operation of the car, positioning is formed with the larger circular hole in the center as the rotation pivot point, and the smaller circular hole and the vertical damper mount are used as the two arms.

A vertical damper is provided at the end of each side beam. The lower end of the vertical damper is hinged on the journal box suspension device, and the upper end is hinged on the side beam through the hinge seat. The vertical damper is mounted vertically.

The railway self-generating express freight car bogie of the present invention has wheel-axle assembly, frame, journal box suspension device, bolster, foundation brake, side bearing, empty/load auto-adjustment equipment, central suspension device, longitudinal traction device, vertical damper, lateral damper, lateral stop, and axle-end generator.

The axle-end generator of the present invention is located outside the journal box suspension device. The axle-end generator is composed of a rotor and a stator. The rotor has a permanent magnet and is connected with the axle by bolts; the stator has a coil and is connected with the journal box by bolts; the rotor rotates together with the axle, the angular speed of rotor rotation is synchronized with the angular speed of axle rotation, and the conductor cuts the magnetic lines of force to generate a voltage (current); the generator can generate electricity when the car is running in both forward and reverse directions.

The primary vibration damping system of the bogie of the present invention is composed of a journal box suspension device and a vertical damper, used to reduce the vibration acceleration when the car is running.

A suspension seat is provided on the inside of the two side beams of the bogie frame of the present invention to reduce the bearing span of the bolster and improve the load condition; the central suspension device of the bogie is placed inside the frame, so that the bolster is shorter in length, lighter in weight and simpler in structure.

The lateral stop of the bogie of the present invention is placed in the middle of the upper plane of the two side beams of the frame; the bogie frame and the bolster of the present invention are welded frame structural parts; the positioning of the bogie journal box suspension device of the present invention is realized by the positioning arm-type journal box.

The beneficial effects of the present invention are as follows. As the bogie is provided with an axle-end generator, it can provide electric energy input for the running state monitoring system of the freight car and various on-board low-power electrical equipment and facilities; The bogie is designed according to the zero-wear concept, and a large number of rubber components and hydraulic dampers are used to improve the lateral stability, linear stability and curve passing performance of the car, so that the bogie is highly adaptable to railway lines, can meet the operating requirements within 160 km/h, and is suitable for various types of express freight cars that run on 1435 mm standard gauge railways in China, such as sliding side box car or roof box car and container flat car; Meanwhile, it also reduces the workload of bogie operation and maintenance.

### DESCRIPTION OF DRAWINGS

FIG. 1 is an axonometric view of the bogie of the present invention.

FIG. 2 is the top view of the bogie of the present invention.

FIG. 3 is a bottom view of the bogie of the present invention.

FIG. 4 is a schematic diagram of the bogie frame of the present invention.

FIG. 5 is a schematic diagram of the installation of the axle-end generator of the bogie of the present invention.

FIG. 6 is a schematic diagram of the composition of the bogie journal box suspension device of the present invention.

Reference numbers: 1—wheel—axle assembly; 1.1—bearing; 2—frame; 2.1—side beam; 2.2—suspension seat; 2.3—lateral stop mount; 3—journal box suspension device; 3.1—journal box body; 3.2—rubber spring; 3.3—positioning arm rubber node; 3.4—vertical damper mount, 4—bolster, 5—foundation brake; 6—side bearing; 7—empty/load auto-adjustment equipment; 8—central suspension device; 9—longitudinal traction device; 10—vertical damper; 11—lateral damper; 12—lateral stop; 13—axle-end generator.

### DETAILED DESCRIPTION

The present invention is further described below in combination with specific embodiments which further illustrate principles of the present invention and do not limit the present invention in any way. The same or similar technologies as the present invention are not beyond the protection scope of the present invention.

Refer to the figures.

The railway self-generating express freight car bogie has wheel-axle assembly 1, frame 2, journal box suspension device 3, bolster 4, foundation brake 5, side bearing 6, empty/load auto-adjustment equipment 7, central suspension device 8, longitudinal traction device 9, vertical damper 10, lateral damper 11, and axle-end generator 13. An axle-end generator 13 is connected at the outer end of an axle of the wheel-axle assembly 1, the rotor part of the axle-end generator 13 is connected to the end bearing 1.1 of the wheel-axle assembly 1 by the axle-end bolts, and the stator part is connected to the mount of the journal box suspension devices 3; the frame 2 is located above the four journal box suspension devices 3, and the two ends of the bolster 4 are respectively fixed on the inner suspension seat 2.2 in the middle of the side beam 2.1 of the frame 2 through the central suspension device 8.

The central suspension device 8 is an elastic element formed by a metal plate and vulcanized rubber.

The journal box suspension device 3 includes the journal box body 3.1 which is connected with the axle of the wheel-axle assembly 1, and the top rubber spring 3.2 of the journal box body 3.1. Meanwhile, to facilitate installation and maintenance of the vertical damper, a vertical damper mount 3.4 is provided at one end of the journal box body, and a circular mounting hole at the other end for mounting the rubber node 3.3 of the positioning arm.

The top rubber spring 3.2 of the journal box body is an elastic element formed by a metal plate and vulcanized rubber.

The rubber node 3.3 of the positioning arm is an elastic element formed by a metal mandrel and vulcanized rubber. The rubber node 3.3 of the positioning arm allows the journal box to have a great displacement in the up and down directions relative to the frame. The design of the rubber part realizes different positioning stiffness of the journal box during longitudinal and transverse displacement to meet the requirements of different elastic positioning stiffness in the longitudinal and transverse directions. The circular mounting hole and the rubber node 3.3 of the positioning arm are in an interference fit.

The frame 2 is connected to the journal box suspension device 3 through the top rubber spring 3.2 of the journal box body 3.1; the vertical damper mount 3.4 at one end of the journal box body 3.1 is connected to the frame side beam 2.1 through the vertical damper 10.

The frame 2 is welded with two sets of box-type side beams 2.1 and two parallel tubular cross beams passing through them. All components arranged on the frame 2 are fixed by welding. A seat 8 is provided on the inner side of the middle part of the side beams 2.1 for mounting the central suspension device. The components include unit braking system hanger, traction device mount, lateral damper mount, brake pipe hanger, suspension seat, lateral stop mount, spherical hinge mount, and vertical damper mount frame.

The foundation brake 5 is a disc brake having four systems matched with four wheels respectively, and each system includes a brake caliper device set arranged on the cross beam and a brake disc device on the axle.

The side beam 2.1 on one side of the frame 2 is provided with empty/load auto-adjustment equipment 7. Longitudinal traction devices 9 connected with the bolster 4 are provided at both ends of the middle part of each cross beam of the frame 2, and a lateral damper 11 connected with the bolster 4 is provided on each side beam 2.1 of the frame 2.

The bolster 4 is a box beam structure welded with stencil plates, including upper cover plate, web plate and lower cover plate; the length of the bolster is smaller than the center distance of the bogie journal and is placed on the inside of the bogie frame 2; the cross-section of the bolster 4 is a U-shaped structure with two wings, with the middle part lower than the two ends.

A lower center plate is provided on the upper surface of the U-shaped structure of the bolster, and a lateral damper mount 11 on the lower surface. Side bearing boxes are provided at the two ends of the U-shaped structure. Traction device mounts are provided at the two ends and the U-shaped transition section of the lower surface of the U-shaped structure of the bolster.

The primary vibration damping system of the bogie is composed of a journal box suspension device 3 and a vertical damper 10.

The side beam 2.1 is a box beam structure welded with stencil plates, including upper cover plate, web plate and lower cover plate; the cross-section of the side beam is a U-shaped structure with two wings, with the middle part lower than the two ends; a suspension seat 2.2 integrated with the lower cover plate is provided on the inner side of the U-shaped structure.

Lateral stop mounts 2.3 are provided in the middle of the upper plane of the U-shaped structure of the two side beams of the bogie frame 2.

The positioning of the bogie journal box suspension device 3 is realized by the positioning arm-type journal box. The journal box has two mounting holes and a vertical damper mount 3.4 to form a positioning arm. The larger hole in the middle is used to fit the axle bearing 1.1, and the smaller hole at one end is used to mount the rubber node 3.3 of the positioning arm. The rubber node 3.3 is connected to the mount welded to the frame 2. The vertical damper mount 3.4 at the other end is connected to the frame through the vertical damper 10. In the dynamic operation of the car, positioning is formed with the larger circular hole in the center as the rotation pivot point, and the smaller circular hole and the vertical damper mount 3.4 are used as the two arms.

A vertical damper 10 is provided at the end of each side beam 2.1. The lower end of the vertical damper 10 is hinged on the journal box suspension device 3, and the upper end is hinged on the side beam 2.1 through the hinge seat. The vertical damper 10 is mounted vertically.

The axle-end generator 13 of the present invention is located outside the journal box suspension device 3. The axle-end generator 13 is composed of a rotor and a stator. The rotor has a permanent magnet and is connected with the axle by bolts; the stator has a coil and is connected with the journal box by bolts; the rotor rotates together with the axle, the angular speed of rotor rotation is synchronized with the angular speed of axle rotation, and the conductor cuts the magnetic lines of force to generate a voltage (current); the generator can generate electricity when the car is running in both forward and reverse directions.

The bogie of the present invention is equipped with a primary vibration damping system composed of a journal box suspension device 3 and a vertical damper 10, used to reduce the vibration acceleration when the car is running;

A suspension seat 2.2 is provided on the inside of the two side beams 2.1 of the bogie frame 2 of the present invention to reduce the bearing span of the bolster and improve the load condition; the central suspension device 8 of the bogie is placed inside the frame 2, so that the bolster 4 is shorter in length, lighter in weight and simpler in structure.

The lateral stop 12 of the bogie of the present invention is placed in the middle of the upper plane of the two side beams 2.1 of the frame 2; the bogie frame 2 and the bolster 4 are welded frame structural parts;

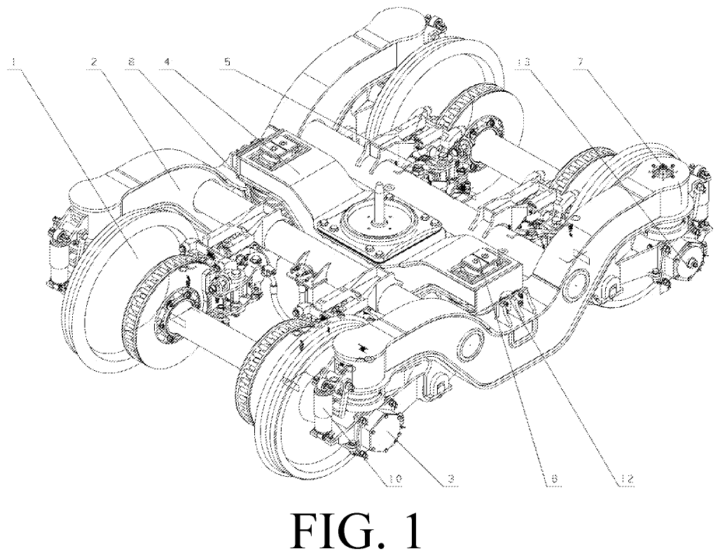

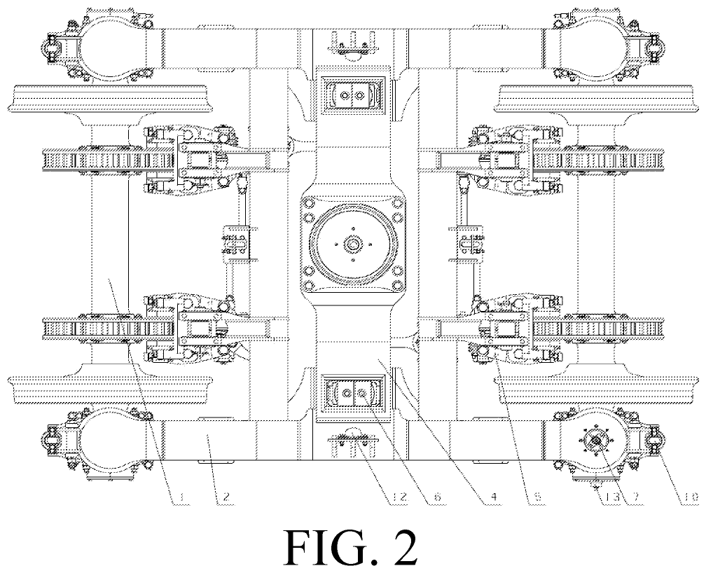

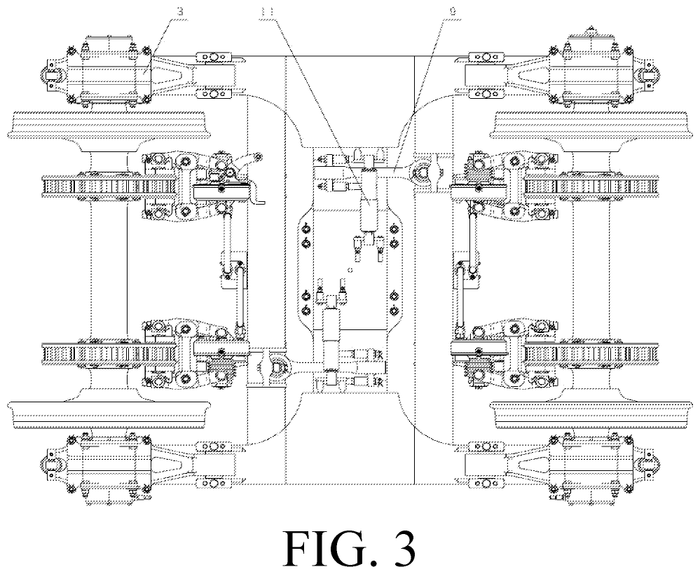

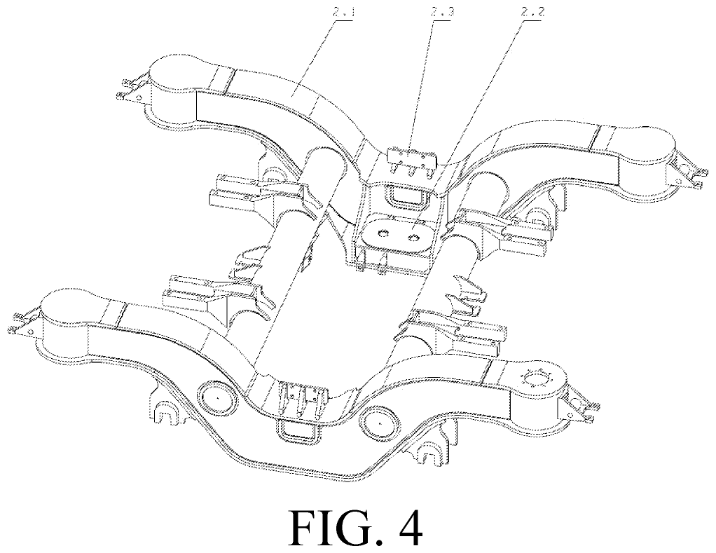

As shown in FIGS. 1 to 4, the bogie of the present invention includes wheel-axle assembly 1, frame 2, journal box suspension device 3, bolster 4, foundation brake 5, side bearing 6, empty/load auto-adjustment equipment 7, central suspension device 8, longitudinal traction device 9, vertical damper 10, lateral damper 11, lateral stop 12, and axle-end generator 13.

A journal box suspension device 3 is installed at both ends of the wheel-axle assembly 1; the frame 2 is located above the four journal box suspension devices 3; a suspension seat 2.2 is provided on the inside of the two side beams 2.1 of the frame 2 for mounting the central suspension device 8; the bolster 4 is placed above the two central suspension devices 8; the foundation brake 5 is installed on the frame 2 through the hanger; a side bearing 6 is located at both ends of the bolster 4, the empty/load auto-adjustment equipment 7 is installed inside the side beams 2.1 of the frame 2; the two ends of the longitudinal traction device 9 and the lateral damper 11 are respectively connected with the mounts on the frame 2 and the bolster 4; the two ends of the vertical damper 10 are respectively connected with the mounts on the frame 2 and the journal box suspension device 3; the two lateral stops 12 are mounted on the side beams 2.1 of the frame 2 through the lateral stop mount 2.3; each bogie is equipped with an axle-end generator 13 mounted on the outside of the journal box suspension device 3.

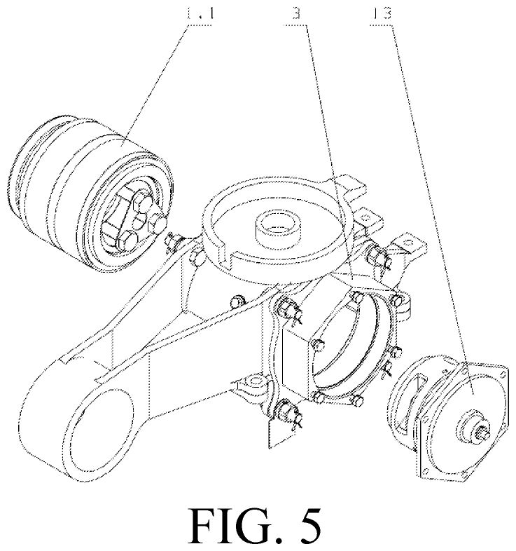

As shown in FIG. 5 , when the axle-end generator 13 is installed, the rotor part is fixed to the bearing 1.1 by the axle-end bolts, and the stator part is fixed to the mount of the journal box suspension device 3 .

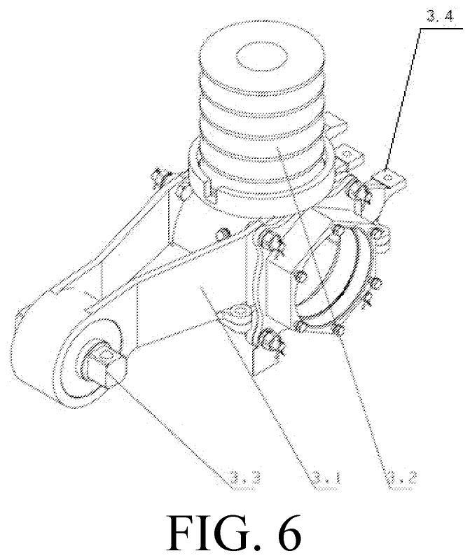

As shown in FIG. 6, the journal box suspension device 3 is composed of a journal box 3.1, a rubber spring 3.2, a spherical hinge 3.3 and a vertical damper mount 3.4.

1. A railway self-generating express freight car bogie, comprising wheel-axle assembly, frame, journal box suspension device, bolster, foundation brake, side bearing, empty/load auto-adjustment equipment, central suspension device, longitudinal traction device, vertical damper and lateral damper, characterized in that: an axle-end generator is connected at the outer end of an axle of the wheel-axle assembly, the rotor part of the axle-end generator is connected to the end bearing of the wheel-axle assembly by the axle-end bolts, and the stator part is connected to the mount of the journal box suspension devices; the frame is located above the four journal box suspension devices, and the two ends of the bolster are respectively fixed on the inner suspension seat in the middle of the side beam of the frame through the central suspension device.

2. A railway self-generating express freight car bogie according to claim 1, characterized in that: the journal box suspension device includes the journal box body which is connected with the axle of the wheel-axle assembly, the top rubber spring of the journal box body, the vertical damper mount provided at one end of the journal box body, and the circular mounting hole at the other end for installing the rubber node of the positioning arm.

3. A railway self-generating express freight car bogie according to claim 2, characterized in that: the central suspension device, the top rubber spring of the journal box body and the rubber node of the positioning arm are all elastic elements formed by metal and vulcanized rubber.

4. A railway self-generating express freight car bogie according to claim 3, characterized in that: the frame is connected to the journal box suspension device through the top rubber spring of the journal box body; the vertical damper mount at one end of the journal box body is connected to the frame side beam through the vertical damper.

5. A railway self-generating express freight car bogie according to claim 3, characterized in that: the frame is welded with two sets of box-type side beams and two parallel tubular cross beams passing through them. All components arranged on the frame are fixed by welding. A seat is provided on the inner side of the middle part of the side beams for mounting the central suspension device.

6. A railway self-generating express freight car bogie according to claim 3, characterized in that: the bolster of the present invention is a box beam structure welded with stencil plates, including upper cover plate, web plate and lower cover plate; the length of the bolster is smaller than the center distance of the bogie journal and is placed on the inside of the bogie frame; the cross-section of the bolster is a U-shaped structure with two wings, with the middle part lower than the two ends.

7. A railway self-generating express freight car bogie according to claim 3, characterized in that: a lower center plate is provided on the upper surface of the U-shaped structure in the middle of the bolster, and a lateral damper mount on the lower surface; side bearing boxes are provided at the two ends of the U-shaped structure; traction device mounts are provided at the two ends and the U-shaped transition section of the lower surface of the U-shaped structure.

8. A railway self-generating express freight car bogie according to claim 3, characterized in that: the bogie is equipped with a primary vibration damping system composed of a journal box suspension device and a vertical damper.

9. A railway self-generating express freight car bogie according to claim 3, characterized in that: the side beam is a box beam structure welded with stencil plates, including upper cover plate, web plate and lower cover plate; the cross-section of the side beam is a U-shaped structure with two wings, with the middle part lower than the two ends; a suspension seat integrated with the lower cover plate is provided on the inner side of the U-shaped structure; lateral stop mounts are provided in the middle of the upper plane of the U-shaped structure of the two side beams of the bogie frame.

10. A railway self-generating express freight car bogie according to claim 3, characterized in that: the positioning of the bogie journal box suspension device is realized by the positioning arm-type journal box.
